(19) United States
(12) Patent Application Publication
(10) Pub. No.: US 2026/0347125 A1
(43) Pub. Date: Nov. 5, 2026

(54) Pouch Conveyor Having A Monitoring Unit And A Methodfor Checking An Unloading State And/Or A Closed State Of A Pouch In A Pouch Conveyor

(71) Applicant: BEUMER GROUP GMBH & CO. KG, Beckum (DE)

(72) Inventors: David HIEBLER, Graz (AT); Robert MÜLLER, Graz (AT)

(21) Appl. No.: 19/571,978

(22) Filed: Mar. 19, 2026

(30) Foreign Application Priority Data
Apr. 30, 2025 (EP) 25173587.4

(51) Int. Cl. B65G 47/38; B65G 17/20; G01S 17/88; G05B 13/02

(52) U.S. Cl. CPC B65G 47/38; B65G 17/20; G01S 17/88; G05B 13/0265; B65G 2203/0266; B65G 2203/044

(57) ABSTRACT

A pouch conveyor, in particular pouch sorter, having a plurality of pouches which are conveyed along a conveying path of the pouch conveyor, wherein the pouch conveyor has at least one unloading station for automatically unloading the multiplicity of pouches. The pouch conveyor comprises at least one monitoring unit which is arranged behind or directly at the at least one unloading station in the conveying direction (x) of the pouches along the conveying path and is designed and configured to detect at least one of the plurality of pouches, in particular visually, and to determine, on the basis of the detection, a state of the at least one pouch, in particular by comparing the detected actual state of the at least one pouch with a setpoint state of the at least one pouch. Furthermore, a method for checking a state, in particular an unloading state and/or a closing state, of a pouch in a pouch conveyor, in particular in a pouch conveyor is disclosed.

### CROSS-REFERENCE TO RELATED APPLICATIONS

The present application is based on, and claims priority from EP Application Serial Number 25173587.4, filed Apr. 30, 2025, the disclosure of which is hereby incorporated by reference herein in its entirety.

### BACKGROUND

### Technical Field

The present invention relates to a pouch conveyor and a method for checking an unloading state and/or a closed state of a pouch in a pouch conveyor. In particular, the present invention relates to a pouch conveyor having a monitoring unit which is designed and configured to determine a state of at least one pouch by, in particular visual, detection in order to optimize an automatic unloading process of the pouch conveyor.

### Discussion

In common applications, pouch sorters have a plurality of 10,000 pouches which can be equipped in each case with a locking mechanism actuated by a drive for automatic pouch unloading. Pouches for automatic unloading which are known from the prior art are disclosed, for example, in EP 4 168 330 A1 and DE 10 2018 201 675 A1.

Further prior art is disclosed in AU 2019 294 099 A1, EP 3 581 523 A1, EP 3 712 091 A1, US 2020/130952 A1, JP S60 178119 A, EP 4 389 653 A1, EP 4 410 715 A1, EP 2 885 231 B1, JP 2000 177835 A and EP 3 972 917 B1.

Even if known systems monitor and control the conveying process, challenges continue to exist, in particular with regard to the accuracy and reliability of automated unloading and closing processes. Thus, in known systems, correct automatic unloading of objects from pouches is checked by light grids which are fitted mechanically at each drop-off place in an unloading region. This is not only costly, but also susceptible to errors, since it is very complex to determine which pouch should have dropped an object and which pouch actually dropped an object at a drop-off place. With current approaches to the solution, it is therefore very difficult to check reliably that an object contained in a pouch has been dropped when it leaves the unloading region.

Furthermore, there is currently no mechanism which can be used to check whether the pouches were successfully closed after the closing process. However, incorrectly closed pouches regularly lead to problems during a new loading operation. Existing approaches for monitoring and controlling pouch conveyors are therefore often unable to carry out a comprehensive and accurate determination of the unloading state and/or closed state of the pouches. This can lead to an increased error rate and a reduced reliability of the system.

It is therefore an aspect of the invention to provide a pouch conveyor and a method for determining an unloading state of at least one pouch, which at least partially overcome the disadvantages of known systems, such that a reliability and cost efficiency of pouch conveyors can be improved.

Accordingly, a pouch conveyor, in particular pouch sorter, having a plurality of pouches which are conveyed along a conveying path of the pouch conveyor is provided. The pouch conveyor has at least one unloading station for automatically unloading the multiplicity of pouches, wherein the pouch conveyor has at least one monitoring unit which is arranged behind or directly at the at least one unloading station in the conveying direction of the pouches along the conveying path and is designed and configured to detect at least one of the plurality of pouches, in particular visually, and to determine, on the basis of the detection, a state of the at least one pouch. The determination of the state can take place in particular by comparing the detected actual state of the at least one pouch with a setpoint state of the at least one pouch.

The term “pouch conveyor” relates to a conveying system which is specifically designed to transport pouches. “Pouch sorter” is a particular type of pouch conveyor which is designed to sort and distribute pouches. The “conveying path” denotes the path which the pouches cover along the conveyor. An “unloading station” is a region in which the pouches are automatically unloaded. An unloading station can have a plurality of drop-off places or unloading places. The “monitoring unit” is a device or system which detects the pouches, in particular visually, and can carry out and/or prompt an evaluation of the detected data.

As a result of the fact that the monitoring unit detects the at least one pouch itself, the invention makes it possible to determine the state, in particular an unloading state, of the detected pouch. In comparison with the systems known from the prior art, therefore, no complicated and error-prone assignment of the emptied object to a corresponding pouch is necessary. Rather, the determined state is linked directly to the corresponding, detected pouch. As a result of the positioning of the monitoring unit behind or directly at the unloading station, a single central monitoring unit can be sufficient, even if the unloading station has a plurality of drop-off places. Since the determination of the unloading state takes place on the basis of the detection of the pouch itself instead of a detection of a dropped object, it is not necessary to provide a monitoring unit at each drop-off places.

The determination of the state preferably comprises the determination of an unloading state and/or a closed state of the at least one pouch. Alternatively or additionally, however, the determination of the state can also comprise a determination of an object hanging out of the pouch and/or a defect on the pouch. It can thus be provided in particular that the setpoint state corresponds to an open state of the pouch and the detected actual state comprises, for example, a distance between two closing elements of the pouch, in particular between two pouch bottom halves.

Furthermore, it can be provided that the comparison of the actual state and the setpoint state takes place on the basis of one or more detected features of the at least one pouch. Such a feature can be, for example, a thickness, a height, a surface finish, a curvature, a width, a contrast, a distance, in particular between movable elements of the pouch, of the at least one pouch.

Furthermore, it can be provided that the monitoring unit is arranged behind or directly at a closing station of the pouch conveyor, wherein the closing station is arranged behind the unloading station in the conveying direction. In this case, the closing station is designed and configured to close the pouches after the automatic unloading. The monitoring unit can then be designed and configured in particular to also determine a closing state of at least one pouch on the basis of the detection. Alternatively or additionally, a first monitoring unit can be arranged behind or directly at the unloading station and a second monitoring unit can be arranged behind or directly at the closing station. Thus, the first monitoring unit can detect at least one pouch after the automatic unloading and, in particular by comparing the detected actual state of the at least one pouch with a setpoint state of the at least one pouch, determine the unloading state of the pouch and the second monitoring unit can detect at least one pouch after the closing and, in particular by comparing the detected actual state of the at least one pouch with a setpoint state of the at least one pouch, determine the closing state.

According to one embodiment, the monitoring unit has at least one sensor for the detection. In this case, the sensor is preferably an optical sensor, in particular a camera with real-time detection. Thus, the sensor can be designed, for example, as LiDAR (light detection and ranging), ToF (time of flight), APD (avalanche photodiode), SPAD (single-photon avalanche diode), ultrasonic sensor, sonar and a radar and/or microwave sensor for FMCW (frequency-modulated continuous-wave radar) or UWB (ultra-wideband). Particularly preferably, the sensor is designed as a TOF (time of flight) sensor, which is distinguished by its ability to measure precise distances and to generate three-dimensional images. A TOF sensor therefore makes it possible to accurately detect the position and the state of the pouches, which is advantageous for the determination of the unloading state.

Preferably, the monitoring unit is designed and configured to detect at least one of the plurality of pouches at least from one side. In this case, the at least one side can be a lower side, an upper side, a front side, a rear side and/or a left-hand or right-hand longitudinal side. Preferably, the monitoring unit is designed and configured to detect the pouch from a side via which the pouch is unloaded. Since, in the case of an open pouch, the monitoring unit can thus detect whether an object is in the pouch or the latter is empty. Additionally or alternatively, the monitoring unit can thus advantageously determine a closed state of the pouch.

In particular, the monitoring unit can be designed and configured to detect at least one of the plurality of pouches from a lower side. The monitoring unit can thus determine, for example on the basis of the detection, whether the pouch is open or closed on its lower side for the purpose of unloading. If the determination results in an open pouch, the monitoring unit can also determine whether an object is in the pouch or the latter is emptied. Alternatively or additionally, the monitoring unit can determine a closed state of the pouch on the basis of the detection from the lower side. For this purpose, the monitoring unit preferably comprises a sensor which is designed as a camera, in particular a real-time-capable camera, and which can film the pouch from below.

Furthermore, the monitoring unit can be designed and configured to detect at least one of the plurality of pouches at least from one longitudinal side. This makes it possible, in particular, to determine a thickness of the at least one pouch. The monitoring unit can then draw conclusions about the unloading state and/or closed state of the pouch using the determined thickness. For this purpose, the monitoring unit comprises, in particular, a sensor designed as LiDAR (light detection and ranging), ToF (time of flight), APD (avalanche photodiode), SPAD (single-photon avalanche diode) or ultrasonic sensor.

In this case, it can be provided, in particular, that the monitoring unit is designed and configured to detect at least one of the pouches from more than one, in particular opposite and/or mutually perpendicularly oriented sides. In a preferred embodiment, it can be provided, for instance, to detect the at least one pouch, in particular simultaneously, from a lower side, a longitudinal side and an upper side. As a result of the detection of a plurality of sides, a reliability and accuracy in the determination of the unloading state and/or closed state of the pouch can be improved. For this purpose, the monitoring unit can comprise two or more sensors which detect the at least one of the plurality of pouches from different, in particular opposite and/or mutually perpendicularly oriented sides.

According to one embodiment, the pouch conveyor has a control unit which is designed and configured to receive and to analyze data determined by the at least one monitoring unit during the detection and to carry out the determination of the state, in particular the unloading state and/or the closed state, of at least one of the pouches on the basis of the analysis. In this case, the control unit can be designed as an integral unit of the monitoring unit or as an external unit. A communication for data transmission between the monitoring unit and the control unit takes place via suitable communication mechanisms which ensure a reliable and rapid transmission of the detected data. These mechanisms can be wired or wireless and make real-time monitoring and control of the pouches possible.

Preferably, the control unit comprises machine learning for analyzing the detected data of the at least one monitoring unit. As a result of the integration of machine learning into the control unit, an advanced data analysis is made possible which allows a more precise and more efficient determination of the unloading state of the pouches. Machine learning relates to the ability of systems to learn from data and to improve themselves without being explicitly programmed. Thus, it is provided in a preferred embodiment that the machine learning comprises a preceding training of an algorithm stored in the control unit and an ongoing improvement of the algorithm. The control unit is therefore able to recognize patterns and anomalies in the detected data and to determine the unloading state and/or closed state of at least one of the multiplicity of pouches on the basis thereof. By means of continuous learning and continuous adaptation to new data over the course of time, the control unit can also provide ever more precise and more reliable results. This is particularly advantageous in environments in which the conditions frequently change or in which there is a high degree of variability in the pouches to be conveyed. Alternatively or additionally, the control unit can comprise algorithms for image processing and pattern recognition for analyzing the detected data.

Preferably, the pouch conveyor is designed and configured to feed the respective pouch of the plurality of pouches to a buffer station, a handling station, a closing station or a return on the basis of the determined state. It is thus possible to prevent or else at least reduce a risk of an incorrectly unloaded or closed pouch being fed to a new loading operation and/or making it possible to unload an incorrectly unloaded pouch in a handling station, for example by removing an object.

A buffer station is understood here to mean a region in which unloaded and closed pouches can be temporarily stored in order to be used again for loading from there. It can also be provided that the buffer station is bypassed and a correctly unloaded and closed pouch is fed directly to a new loading operation. A handling station is understood to mean a region in which, in particular, incorrectly unloaded pouches can be checked manually. Correctly unloaded pouches can be fed to the closing station for closing.

The feeding takes place in this case on the basis of the determined state. If the determination of the state reveals that a pouch is incorrectly unloaded, the pouch conveyor feeds the corresponding pouch to the handling station. If the determination of the state reveals that a pouch is correctly unloaded, the pouch conveyor feeds the corresponding pouch to the closing station. If the determination of the state reveals that a pouch is incorrectly closed, the pouch conveyor feeds the corresponding pouch again to the closing station. For this purpose, a return can be provided, for example. If the determination of the state reveals that a pouch is correctly closed, the pouch conveyor feeds the corresponding pouch to the buffer station or directly to a loading station.

According to one embodiment, the plurality of pouches in each case has an individual identifier. In this case, the individual identifier can be designed as a QR barcode or barcode, but in particular electronically, for example as an RFID transponder. By means of the individual identifier, the invention makes precise identification and tracking of a specific pouch within the plurality of pouches possible.

Preferably, in this case, the at least one monitoring unit is designed and configured to detect the identifier of at least one of the plurality of pouches and to transmit it to the control unit with the detected data of the at least one pouch. The invention thus makes it possible for detected data and identifier of a pouch to be fed to the control unit in a manner linked to one another. The specific state can thus be assigned to the correct pouch in a simple manner, with low susceptibility to errors. In this case, the detection of the identifier can in particular comprise a readout of the identifier from a PLC (programmable logic controller), HLC (high level control) and/or WCS (warehouse control system).

A further aspect of the invention relates to a method for checking a state, in particular an unloading state and/or closing state, of a pouch in a pouch conveyor, in particular in a pouch conveyor according to the invention, wherein the method comprises:
conveying at least one pouch, preferably a plurality of pouches, particularly preferably a batch of a certain number of pouches, along the pouch conveyor;
feeding the pouch to an unloading station and/or a closing station of the pouch conveyor; and
checking a state of the pouch by means of an, in particular visual, detection of the pouch in the conveying direction of the plurality of pouches behind or directly at the unloading station and/or behind or directly at the closing station.

As a result of the checking taking place on the basis of a detection of the pouch, the state can be checked directly on the basis of a detected feature of the pouch. In comparison with a method, this has the effect that an unloading operation is determined on the basis of a detected, dropped object, an assignment to a specific pouch is simplified and a susceptibility to errors can therefore be reduced. The determination of the state can take place in this case in particular on the basis of a comparison of the detected feature of the at least one pouch with a setpoint state of the feature of the at least one pouch. In particular, a sensor can be used for the detection. Furthermore, the detection can take place from more than one spatial direction.

In particular, a detection from a lower side of the pouch can take place. This is advantageous in particular if, in order to unload the pouch, a bottom of the pouch is opened and/or, in order to close the pouch, the bottom of the pouch is opened. This is because an opening state of the pouch bottom can thus be detected directly. Preferably, a checking of the closing state can take place on the basis of a checking of the closing state of the bottom of the pouch by preferably determining a distance between two pouch bottom halves for closing the pouch bottom.

The pouch conveyor according to the invention is suitable in particular for carrying out the method according to the invention. The details and advantages disclosed for the pouch conveyor according to the invention can be transferred and applied to the method according to the invention and vice versa.

### BRIEF DESCRIPTION OF THE DRAWINGS

Further details of the invention are explained on the basis of the following figure. In the figures:

FIG. 1 shows an exemplary embodiment of a pouch conveyor according to the invention.

### DESCRIPTION OF EXEMPLARY EMBODIMENTS

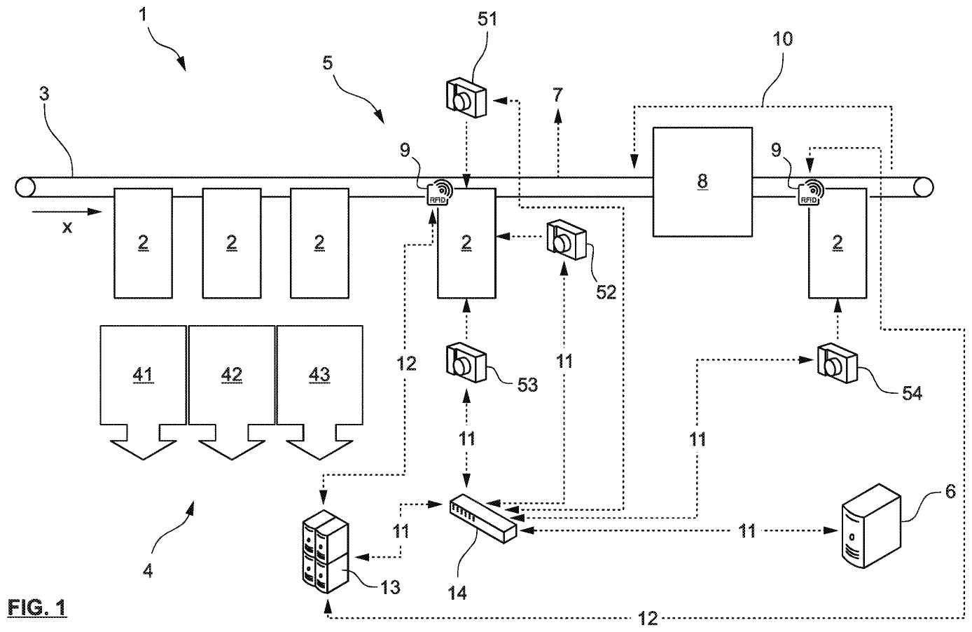

FIG. 1 shows, in a schematic illustration, an embodiment of a pouch conveyor 1 designed as a pouch sorter. A multiplicity of pouches 2, which can open and close a bottom for the automatic unloading, are conveyed along a conveying path 3 of the pouch conveyor. The pouch conveyor 1 has, for the automatic unloading of the multiplicity of pouches 2, an unloading station 4 having a plurality of unloading place 41, 42, 43. Furthermore, the pouch conveyor 1 has a closing station 8 arranged behind the unloading station in the conveying direction x.

The pouch conveyor also has a monitoring unit 5 having a plurality of sensors 51, 52, 53, 54. In this case, the sensors 51, 52, 53, 54 are all designed as TOF sensors. In an alternative exemplary embodiment, only the sensor 52 can be designed as a TOF sensor. The further sensors 51, 52, 53 can then be designed as a camera, in particular a real-time-capable camera. In further, alternative exemplary embodiments, at least one of the sensors 51, 52, 53, 54 can be designed as LiDAR (light detection and ranging), APD (avalanche photodiode), SPAD (single-photon avalanche diode), ultrasonic sensor, sonar and a radar and/or microwave sensor for FMCW (frequency-modulated continuous-wave radar) or UWB (ultra-wideband).

In this case, the sensors 51, 52, 53 are arranged directly behind the unloading station 4 in the conveying direction x and are positioned such that the sensor 51 visually detects a pouch 2 from above, the sensor 52 from a longitudinal side and the sensor 53 from a lower side. Thus, by means of the sensor 51, an internal volume of the pouch 2 can be visually detected from the upper side of the pouch 2. The sensor 53 can visually detect from the lower side whether the bottom of the pouch 2 is open or closed. If the bottom is open, the sensor 53 can also visually detect an internal volume of the pouch 2. The sensor 52 in turn allows a thickness determination of the pouch 2, via which an unloading state of the pouch 2 can be inferred.

The sensor 54 is arranged directly behind the closing station 8 in the conveying direction x and is positioned such that it visually detects a pouch 2 from a lower side. Thus, the sensor 54 can visually detect whether a bottom of the pouch 2 is open or closed.

The pouch conveyor 1 is in this case designed and configured to carry out a method for checking a state of a pouch 2 in the pouch conveyor 1, which method comprises:
conveying at least one pouch 2, preferably a plurality of pouches 2, particularly preferably a batch of a certain number of pouches 2, along the pouch conveyor 1;
feeding the pouch 2 to the unloading station 4 and the closing station 8 of the pouch conveyor 1; and
checking a state, in this case an unloading state and/or closed state, of the pouch 2 by means of the sensors 51, 52, 53, 54 in the conveying direction x of the plurality of pouches 2 behind the unloading station 4 or behind the closing station 8.

The checking in this case comprises, in addition to the visual detection of the pouch 2, a determination of the unloading state and/or the closed state on the basis of the visual detection. For this purpose, the pouch conveyor 1 comprises a control unit 6 which is designed as a high-level control and which is designed and configured to receive and to analyze data determined by the sensors 51, 52, 53, 54 during the visual detection. On the basis of the analysis, the control unit 6 can then determine the unloading state of the pouch, for example on the basis of the data detected visually by the sensors 51, 52, 53, and/or determine the closed state of the pouch 2 on the basis of the data detected visually by the sensor 54. The control unit 6 is designed as a unit separate from the monitoring unit 5. In other exemplary embodiments (not shown), the monitoring unit 5 and the control unit 6 can be designed as one unit.

In order to transmit the detected data, the sensors 51, 52, 53, 54 and the control unit 6 are connected to one another in a wired manner here. In the exemplary embodiment shown in FIG. 1, the communication takes place in this case by means of Ethernet 11, in that the control unit 6 and the sensors 51, 52, 53, 54 are connected via a network switch 14. The communication between the control unit 6 and the sensors 51, 52, 53, 54 can be implemented differently, in particular wirelessly, in other exemplary embodiments.

In this case, the plurality of pouches 2 in each case has an individual identifier 9, which is designed in this case electronically as an RFID transponder. This identifier 9 can be read out by means of a machine controller 13 designed as a programmable logic controller, wherein the readout of the identifier 9 takes place in particular in parallel with the visual detection by the sensors 51, 52, 53 or the sensor 54. For this purpose, the machine controller 13 can be connected to a corresponding reader for reading out the identifier 9, in this case for example by means of Profinet 12.

The readout identifier 9 of a specific pouch 2 is then transmitted to the control unit 6 by the machine controller 13 with the visually detected data by the sensors 51, 52, 53 or by the sensor 54. Thus, the visually detected data can be assigned unambiguously to the specific pouch 2 in an uncomplicated manner and with a low error rate.

The control unit 6 can comprise machine learning for analyzing the detected data. Thus, it can be provided, for example, that an algorithm stored in the control unit 6 is suitably pretrained for the analysis and is continuously improved during operation. The machine learning therefore makes it possible to efficiently recognize patterns and features in the detected visual data. Furthermore, the control unit 6 can comprise commands for image evaluation and/or image processing in order to make an evaluation of the visually detected data possible.

In this case, the pouch conveyor 1 is designed and configured to feed the respective pouch 2 of the plurality of pouches 2 to a buffer station, a handling station 7 or a closing station 8 on the basis of the determined unloading state and/or the determined closed state. For this purpose, it can be provided, for example, that the control unit 6, where the specific state is stored in a manner assigned to the readout identifier 9 of the respective pouch 2, determines the next destination of the pouch 2 on the basis of the determined state. The control unit 6 can then transmit the determined destination to the machine controller 13, with the result that the pouch 2 can be fed to the next destination in accordance with its state.

The pouch conveyor 1 can therefore be designed and configured to feed a pouch 2 either to the handling station 7 for manual checking or to the closing station 8 for closing on the basis of the determined unloading state. On the basis of the determined closed state of a pouch 2, the pouch conveyor 1 can be designed and configured to feed the pouch 2 to the closing station again via a return 10 and to forward it to the buffer station or directly to a loading station for new loading.

The pouches 2 can be designed such that, in order to unload the pouches 2, a bottom of the pouches 2 is opened and/or, in order to close the pouches 2, the bottom of the pouches 2 is closed. It can then be provided during the determining that the checking of the closing state of the pouches 2 comprises the checking of the closing state of a pouch bottom of the pouches 2, wherein preferably the distance between two pouch bottom halves for closing the pouch bottom is determined.

The features of the invention which are disclosed in the above description, in the drawings and in the claims can be essential both individually and in any desired combination for the realization of the invention.

1. A pouch conveyor, in particular pouch sorter, having a plurality of pouches which are conveyed along a conveying path of the pouch conveyor, wherein the pouch conveyor has at least one unloading station for automatically unloading the multiplicity of pouches, comprising wherein the pouch conveyor has at least one monitoring unit which is arranged behind or directly at the at least one unloading station in the conveying direction (x) of the pouches along the conveying path and is designed and configured to detect at least one of the plurality of pockets, in particular visually, and to determine, on the basis of the detection, a state of the at least one pocket, in particular by comparing the detected actual state of the at least one pocket with a setpoint state of the at least one pocket.

2. The pouch conveyor according to claim 1, in which the determined state is or comprises an unloading state and/or a closed state of the at least one pouch, in particular in that the setpoint state of the at least one pouch corresponds to an open state of the pouch.

3. The pouch conveyor according to claim 1, in which the monitoring unit has at least one sensor for detecting, particularly preferably at least one TOF (time of flight) sensor, a LiDAR (light detection and ranging) sensor, an APD (avalanche photodiode), an SPAD (single-photon avalanche diode), an ultrasonic sensor, a sonar, a radar and/or a microwave sensor.

4. The pouch conveyor according to claim 1, in which the monitoring unit is designed and configured to detect at least one of the plurality of pouches at least from one side.

5. The pouch conveyor according to claim 4, in which the monitoring unit is designed and configured to detect at least one of the plurality of pouches at least from a lower side and/or upper side.

6. The pouch conveyor according to claim 4, in which the monitoring unit is designed and configured to detect at least one of the plurality of pouches at least from one longitudinal side and in particular to determine a thickness of the at least one pouch.

7. The pouch conveyor according to claim 1, in which the at least one monitoring unit comprises two sensors which detect at least one of the plurality of pouches from different, in particular opposite and/or mutually perpendicularly oriented sides.

8. The pouch conveyor according to claim 1, having a control unit which is designed and configured to receive and to analyze data determined by the at least one monitoring unit during the detection and to carry out the determination of the state of at least one of the pouches on the basis of the analysis.

9. The pouch conveyor according to claim 8, in which the control unit comprises machine learning for analyzing the detected data of the at least one monitoring unit.

10. The pouch conveyor according to claim 9, in which the machine learning comprises a preceding training of an algorithm stored in the control unit and an ongoing improvement of the algorithm.

11. The pouch conveyor according to claim 1, in which the pouch conveyor feeds the respective pouch of the plurality of pouches to a buffer station, a handling station, a closing station or a return on the basis of the determined state.

12. The pouch conveyor according to claim 1, in which the plurality of pouches in each case has an individual, in particular electronic, identifier.

13. The pouch conveyor according to claim 12, in which the at least one monitoring unit is designed and configured to detect the identifier of at least one of the plurality of pouches and to transmit it to the control unit with the detected data of the at least one pouch.

14. A method for checking a state, in particular an unloading state and/or a closing state, of a pouch in a pouch conveyor, in particular in a pouch conveyor according to claim 1, wherein the method comprises:
conveying at least one pouch, preferably a plurality of pouches, particularly preferably a batch of a certain number of pouches (2), along the pouch conveyor;
feeding the pouch to an unloading station and/or a closing station of the pouch conveyor; and
checking a state of the pouch by means of an, in particular visual, detection of the pouch in the conveying direction (x) of the plurality of pouches behind or directly at the unloading station and/or behind or directly at the closing station.

15. The method according to claim 14, wherein the checking comprises detecting the pouch from more than one spatial direction.

16. The method according to claim 14, wherein the checking comprises analyzing the detected data, wherein the analyzing comprises using machine learning.

17. The method according to claim 14, wherein, on the basis of the checking, the pouch is conveyed into a buffer station, a handling station, into the closing station and/or into a return.

18. The method according to claim 14, wherein, in order to unload the pouch, a bottom of the pouch is opened and/or, in order to close the pouch, the bottom of the pouch is closed.

19. The method according to claim 14, wherein the checking of the closing state of the pouch comprises the checking of the closing state of a pouch bottom of the pouch, wherein preferably the distance between two pouch bottom halves for closing the pouch bottom is determined.
